(19) United States
(12) Patent Application Publication
(10) Pub. No.: US 2008/0029022 A1
(43) Pub. Date: Feb. 7, 2008

(54) DEVICE FOR AUTOMATICALLY PASTING SHEETS OF PAPER OR CARDBOARD

(75) Inventors: LAURENT BOURDELAIN, REVEL (FR); PATRICE LAVERGNE, MONTEYNARD (FR)

Correspondence Address: CANTOR COLBURN, LLP, 55 GRIFFIN ROAD SOUTH, BLOOMFIELD, CT, 06002, US

(73) Assignee: KIS, ECHIROLLES (FR)

(21) Appl. No.: 11/768,548

(22) Filed: Jun. 26, 2007

(30) Foreign Application Priority Data
Aug. 1, 2006 (FR) 06 53244

(51) Int. Cl. B29C 65/52; B05C 1/00

(52) U.S. Cl. 118/33; 118/249; 118/241; 118/231

(57) ABSTRACT

This device for automatically pasting sheets of paper or cardboard having a low substance including a storage spool for a backing covered in a film of transfer adhesive, a motor means intended to ensure unwinding of the backing from storage spool and transport of the backing towards a pasting area, an adhesive applicator roll which can move between two positions, an operational position in which the adhesive applicator roll comes into contact with a pressure roll and between which the sheet to be pasted can move and a non-operational position in which the adhesive applicator roll is no longer in contact with the pressure roll or the sheet of paper or cardboard.

### FIELD OF THE INVENTION

The present invention relates to a device designed to automatically paste sheets of paper or cardboard together so as to allow their assembly in order to produce a more complex structure such as, in particular, an album or a book.

More specifically, this pasting device is designed to be integrated into a more complex unit designed to produce such a structure, album or book semi-automatically, for example to produce photo albums.

### DESCRIPTION OF THE PRIOR ART

The production of books or works is currently largely automated, the various leaves which constitute them being assembled in the area of a hinge with the border of each of the gathered sheets being pasted in the area of the latter.

The problem encountered differs if the album and, generally speaking, the work is the result of pasting, substantially over the entire area of the page in question, one sheet onto another.

In this configuration, the aim is, as far as possible, to use an adhesive transfer film instead of a liquid adhesive.

### BRIEF SUMMARY OF THE INVENTION

The invention proposes a relatively simple structure that allows the transfer of such a film of transfer adhesive from a backing onto all or part of the surface of a leaf, especially a photographic plate, whether the latter is obtained using a digital or silver-based emulsion method.

The invention therefore relates to a device for automatically pasting sheets of paper or cardboard having a low substance, comprising:
a storage spool for a backing covered in a film of transfer adhesive;
a motor means intended to ensure unwinding of the backing from the storage spool and transport of the latter in a pasting area;
a movable adhesive applicator roll which has two positions:
   an operating position in which said adhesive applicator roll comes into contact with a pressure roll, the sheet that is to be pasted being capable of moving between these two rolls;
   and a non-operational position in which the adhesive applicator roll is no longer in contact with the pressure roll or the sheet of paper or cardboard.

According to one advantageous aspect of the invention, the support shaft of the adhesive applicator roll is capable of moving within transverse slots. In addition, in the absence of any applied force, said adhesive applicator roll naturally assumes its operational position; a spring system holds it in this configuration.

The adhesive applicator roll only assumes its non-operational position due to the action of an actuator which also causes disengagement or stoppage of the motor means which ensures unwinding of the backing covered with the transfer adhesive.

According to the invention, the device comprises a take-up spool for the adhesive film backing which is therefore free of transferable adhesive. According to one aspect of the invention, this storage spool for the backing is motor driven and ensures the function of the above-mentioned motor means and, in particular, unwinding of the backing, covered in transfer adhesive, from its storage spool; and effective tensioning of the backing after the adhesive film has been deposited on the sheet of paper or cardboard.

In fact, the rewinding system only takes up the backing of the film released by pasting, the length of which is determined by the roll of the machine which cooperates with the adhesive applicator roll which is driven by stepper motor. The length of adhesive paid out is thus exactly the same as the length of paper pasted.

According to one advantageous aspect of the invention, the two storage spools for the backing covered in transfer adhesive and the backing free of transfer adhesive respectively are mounted on removable shafts so as to ensure their interchangeability and, consequently, make it possible to change the format of the backing and hence that of the transferable adhesive film and therefore, consequently, its adaptation to match various sizes of sheets to be pasted.

### BRIEF DESCRIPTION OF THE DRAWINGS

The way in which the invention is implemented and its resulting advantages will be made more readily understandable by the description of the following embodiment, given merely by way of example, reference being made to the accompanying drawings.

FIG. 1 is a schematic perspective view of the device for pasting in accordance with the invention.

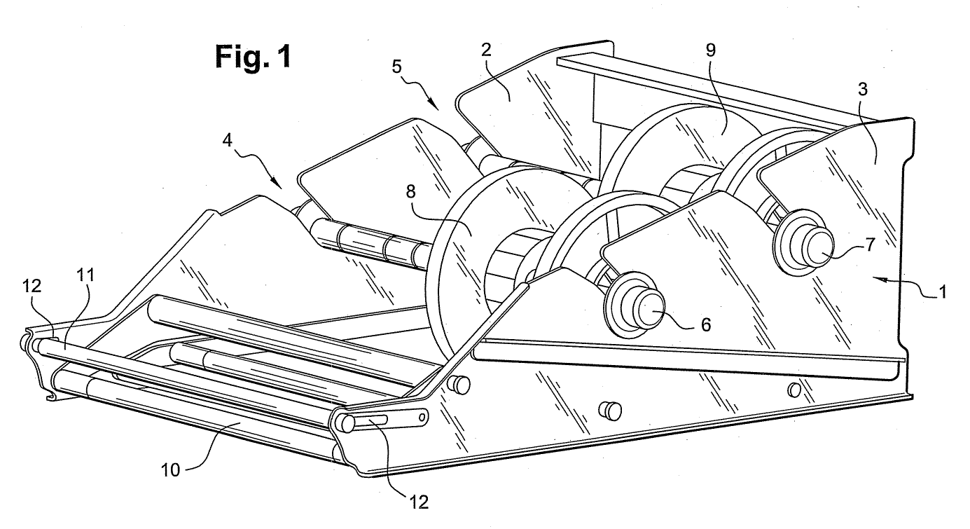

FIG. 2 is a side view of the device for pasting shown in FIG. 1.

### DETAILED DESCRIPTION OF THE INVENTION

The device according to the invention comprises of a cassette capable of being inserted into a receptacle provided for this purpose fitted in a more complex installation for producing a work and, more especially, a photo album which is described in a patent application filed by the Applicant on the same date as this application.

This device therefore comprises a chassis (1) equipped with two side plates (2) and (3) which are parallel to each other. Each side plate has two slots or through slits (4) and (5) located opposite each other in pairs and suitable for accommodating shafts (6) and (7) which support two spools (8) and (9).

Spool (8) is designed to store a backing covered with a transferable adhesive film, such as film marketed by the companies 3M or TESA. Typically, the backing is non-adhesive and is, for example, made of silicone. The transferable adhesive film is made of an acrylic or vinyl-based material or other material. However, acrylic is the most suitable material for obtaining durable bonding of photographic paper.

Spool (9) is designed to store the silicone backing stripped of its adhesive film, i.e. after the latter has been deposited on the sheet of paper or cardboard.

Because of the use of through slots (4, 5), spools (8, 9) can be changed very easily, thus making it possible to change the size of the sheets that are to be pasted.

According to the invention, spool (9) and, more specifically, shaft (7) which accommodates it, is driven by means of an electric motor which is not shown. This being so, spool (9) ensures unwinding of the backing covered in adhesive film from spool (9) and, consequently, tensioning of the backing after transfer of the adhesive in order to avoid any risk of it continuing its transport at the same time as the backing covered in adhesive film.

According to the invention, the device according to the invention comprises a fly roller (10) located downstream from spool (8) around which, firstly, the backing covered in adhesive film is partially wound and, secondly, around which the backing without adhesive film is partially wound, i.e. after travelling around adhesive applicator roll (11). There is therefore friction only on the backing at this level and this is not a problem because of the non-adhesive nature of the silicone material of which it is made. Also, this encourages locking of the adhesive film when the roller is not in contact with the paper. The movement of the paper releases the friction and allows recovery of the used film by the motor-driven spool.

According to the invention, adhesive applicator roll (11) can move between two respective operational positions:
a default position in which it can paste in cooperation with a motor-driven pressure roll fitted in a more complex structure of the same type as that described in the patent filed on the same date by the Applicant.
and a non-operational position in which roll (11) is retracted and, in particular, in which it is no longer in contact with said pressure roll, the sheet of paper or cardboard then being able to move freely at this level. The tension of the adhesive film is contained by the friction resulting from superimposing the standby adhesive film and the used adhesive film.

Thanks to the action of the motor-driven roll of the system in which the device according to the invention is designed to be fitted, the adhesive follows the paper to be pasted due to the pressure of the adhesive applicator roll and because of a movement of said motor-driven roll.

To achieve this, the ends of the support shaft of adhesive applicator roll (11) are each accommodated in a through slot (12) made in side plates (2, 3).

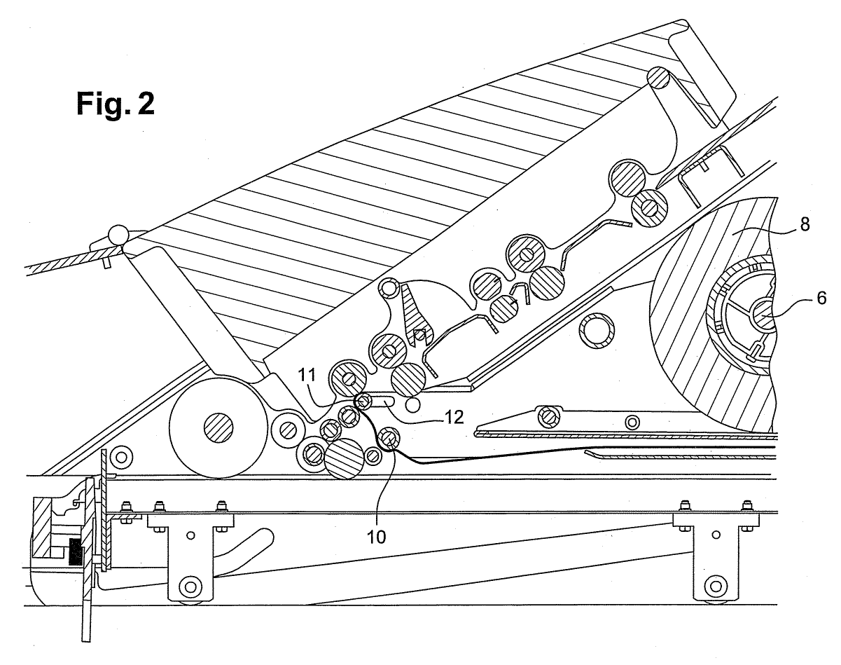

When no force is applied, the adhesive applicator roll is held in its operational position, i.e. on the left of the through slot in FIG. 2 by the action of a spring base rod (not shown).

Adhesive applicator roll (11) is pushed into the bottom of through slot (12) (on the right in FIG. 2) by the action of an actuator (not shown). This actuator is capable of being operated at a relatively high speed so as to cause breakage of the adhesive film when it is actuated, thus preventing continuation of un-bonding from the backing despite the fact the pasting operation has ended.

Other than during pasting phases, the sheet to be pasted travels between the pressure roll and adhesive applicator roll (11) which is then in its non-operational position. The programmable logic controller which controls the device causes, in this configuration, disengagement or stoppage of the electric motor which rotationally drives spool (9). Advantageously, it is the reduction in the intensity of the current supplied to the motor of the spool which generates a tensile force sufficient to ensure the backing is maintained in its tensioned position.

In contrast, during the pasting phase, the actuator acting on the adhesive applicator roll ceases to exert thrust on said roll at the level of the end of through slots (12) so that said adhesive applicator roll naturally returns and presses against the pressure roll, and hence against the verso of the sheet to be pasted, thereby positioning at this level the adhesive film which then moves at this level due to the tensile force exerted by spool (9) because its motor is once again engaged or energised.

It is pointed out that the transport speed of the sheet to be pasted is the same as the feed speed of the backing of the transferable adhesive film because the adhesive film is deposited on the desired surface of the sheet simply by pressure.

After transfer, the backing, stripped of its transferable adhesive, is returned via fly roller (10) to spool (9) used to store said backing.

The simple operation of the pasting device in accordance with the invention is apparent: using a simple programmable logic controller, which itself operates in accordance with predetermined parameters, particularly the length of the sheet of paper to be pasted, makes it possible to simultaneously operate the actuator that acts on the adhesive applicator roll and operate the motor which ensures unwinding from storage spool (8) and rewinding on storage spool (9).

1. A device for automatically pasting sheets of paper or cardboard having a low substance, comprising:
a storage spool for a backing covered in a film of transfer adhesive;
a motor means intended to ensure unwinding of the backing from the storage spool and transport of the backing towards a pasting area; and
an adhesive applicator roll which can move between two positions:
an operational position in which said adhesive applicator roll comes into contact with a pressure roll and between which the sheet to be pasted can move;
a non-operational position in which the adhesive applicator roll is no longer in contact with the pressure roll or the sheet of paper or cardboard.

2. A device for automatically pasting sheets of paper or cardboard having a low substance as claimed in claim 1, wherein a support shaft of the adhesive applicator roll is capable of moving inside through slots made in a chassis that defines the device.

3. A device for automatically pasting sheets of paper or cardboard having a low substance as claimed in claim 2, wherein when no force is applied, the adhesive applicator roll is naturally in the operational position; wherein a spring system ensures that the roll is held in this configuration.

4. A device for automatically pasting sheets of paper or cardboard having a low substance as claimed in claim 1, wherein the adhesive applicator roll is only in the non-operational position due to the effect of an actuator, operation of which also causes disengagement or stoppage of the motor means which ensures unwinding of the backing covered in transfer adhesive.

5. A device for automatically pasting sheets of paper or cardboard having a low substance as claimed in claim 1, further comprising a spool for receiving the backing of the adhesive film stripped of the transferable adhesive.

6. A device for automatically pasting sheets of paper or cardboard having a low substance as claimed in claim 5, wherein the storage spool for the backing stripped of the transfer adhesive is motor driven and ensures a function of the motor means including unwinding of the backing covered in transfer adhesive from the storage spool and effective tensioning of the backing after the adhesive film has been deposited on the sheet of paper or cardboard.

7. A device for automatically pasting sheets of paper or cardboard having a low substance as claimed in claim 5, wherein the two storage spools, for the backing covered in transfer adhesive and for the backing stripped of transfer adhesive respectively, are mounted on removable shafts so as to ensure their interchangeability and, consequently, make it possible to change the size of the backing and hence that of the transferable adhesive film and, consequently, make it possible to adapt it to various sizes of sheets to be pasted.
